(19) United States
(12) Patent Application Publication
(10) Pub. No.: US 2024/0288169 A1
(43) Pub. Date: Aug. 29, 2024

(54) FUEL INJECTOR AIR SWIRLER STRUCTURE WITH CANTED FLOW GUIDE SURFACE

(71) Applicant: Raytheon Technologies Corporation, Farmington, CT (US)

(72) Inventors: Baris A. Sen, S. Glastonbury, CT (US); Andrew W. Justice, Tolland, CT (US); Stephen K. Kramer, Cromwell, CT (US); Gary J. Dillard, Gainsville, FL (US)

(21) Appl. No.: 18/114,691

(22) Filed: Feb. 27, 2023

(51) Int. Cl. F23R 3/28; F02C 7/232

(52) U.S. Cl. CPC F23R 3/286; F02C 7/232; F05D 2220/32; F05D 2240/36

(57) ABSTRACT

An assembly is provided for a turbine engine. This turbine engine assembly includes an air swirler structure, an injector nozzle and a nozzle guide. The air swirler structure includes a swirler wall, an inner passage and an air swirler passage. The swirler wall includes a flow guide surface. At least an inner portion of the flow guide surface has a frustoconical geometry. The inner passage extends axially along an axis within the air swirler structure to a swirler outlet. The air swirler passage extends radially into the air swirler structure, longitudinally along the flow guide surface and to the inner passage. The injector nozzle projects axially into the inner passage. The nozzle guide couples the injector nozzle to the air swirler structure. The nozzle guide is axially abutted against the swirler wall.

### BACKGROUND OF THE DISCLOSURE

### 1. Technical Field

This disclosure relates generally to a gas turbine engine and, more particularly, to a fuel injector assembly for the gas turbine engine.

### 2. Background Information

Various types and configurations of fuel injector assemblies are known in the art. Some of these known fuel injector assemblies include an air swirler mated with a fuel injector nozzle. While these known fuel injector assemblies have various advantages, there is still room in the art for improvement.

### SUMMARY OF THE DISCLOSURE

According to an aspect of the present disclosure, an assembly is provided for a turbine engine. This turbine engine assembly includes an air swirler structure, an injector nozzle and a nozzle guide. The air swirler structure includes a swirler wall, an inner passage and an air swirler passage. The swirler wall includes a flow guide surface. At least an inner portion of the flow guide surface has a frustoconical geometry. The inner passage extends axially along an axis within the air swirler structure to a swirler outlet. The air swirler passage extends radially into the air swirler structure, longitudinally along the flow guide surface and to the inner passage. The injector nozzle projects axially into the inner passage. The nozzle guide couples the injector nozzle to the air swirler structure. The nozzle guide is axially abutted against the swirler wall.

According to another aspect of the present disclosure, another assembly is provided for a turbine engine. This turbine engine assembly includes an air swirler structure, an injector nozzle and a nozzle guide. The air swirler structure includes a swirler wall, an inner passage and an air swirler passage. The swirler wall extends along a centerline to a distal inner end of the swirler wall. The centerline includes a radial component and an axial component. The inner passage extends axially along an axis within the air swirler structure to an outlet from the air swirler structure. The air swirler passage extends radially into the air swirler structure, longitudinally along the swirler wall and to the inner passage. The injector nozzle projects axially into the inner passage. The nozzle guide couples the injector nozzle to the air swirler structure. The nozzle guide is configured to axially abut against the swirler wall.

According to still another aspect of the present disclosure, another assembly is provided for a turbine engine. This turbine engine assembly includes an air swirler structure, an injector nozzle and a nozzle guide. The air swirler structure includes a swirler wall, an inner passage and an air swirler passage. The inner passage extends axially along an axis within the air swirler structure. The air swirler passage extends radially into the air swirler structure, longitudinally along the swirler wall and to the inner passage. The injector nozzle projects axially into the inner passage. The nozzle guide couples the injector nozzle to the air swirler structure. The nozzle guide is configured to axially engage the swirler wall. The swirler wall is configured to direct air flowing out of the air swirler passage into the inner passage downstream and away from a corner between the nozzle guide and the injector nozzle.

A trajectory of the centerline at the distal inner end of the swirler wall may point at a tip of the injector nozzle.

The swirler wall may include a flow guide surface. At least an inner portion of the flow guide surface at the distal inner end of the swirler wall may have a frustoconical geometry. The nozzle guide may be slidable along the swirler wall.

The air swirler structure may also include a mounting plate connected to the

swirler wall. An outer portion of the nozzle guide may be received within a receptacle formed by and axially between the swirler wall and the mounting plate.

The nozzle guide may be radially abutted against the injector nozzle.

The nozzle guide may circumscribe and may be slidable axially along the injector nozzle.

At least a portion of the frustoconical geometry may follow a straight line trajectory in a reference plane parallel with the axis.

At least a portion of the frustoconical geometry may follow a curved trajectory in a reference plane parallel with the axis.

The swirler wall may be a first swirler wall. The air swirler structure may also include a second swirler wall and a plurality of swirler vanes. The air swirler passage may be formed by and may be axially between the first swirler wall and the second swirler wall. Each of the swirler vanes may extend axially across the air swirler passage from the first swirler wall to the second swirler wall.

The swirler vanes may be connected to a radial outer portion of the first swirler wall. A radial inner portion of the first swirler wall may include the inner portion of the flow guide surface having the frustoconical geometry.

An outer portion of the flow guide surface may have a planar geometry.

An outer portion of the flow guide surface may be perpendicular to the axis.

The swirler wall may extend along a centerline to a distal inner end of the swirler wall. The centerline may have a trajectory extending towards a tip of the injector nozzle.

A purge aperture may extend axially across the nozzle guide.

The nozzle guide may include a foot that radially engages the injector nozzle. A first portion of the foot may radially taper towards the injector nozzle as the first portion of the foot projects axially into the inner passage along the injector nozzle.

A second portion of the foot, axially opposite the first portion of the foot, may radially tapers away from the injector nozzle as the second portion of the foot projects axially along the injector nozzle.

The air swirler passage may be a first air swirler passage. The air swirler structure may also include a second air swirler passage. The first air swirler passage may be axially between the second air swirler passage and the swirler wall. The second air swirler passage may extend radially into the air swirler structure towards and may be fluidly coupled with the inner passage.

The air swirler passage may be a first air swirler passage. The air swirler structure may also include an annulus and a second air swirler passage. The annulus may be radially outboard from the inner passage. The annulus may extend circumferentially about and axially along the inner passage. The second air swirler passage may extend radially into the air swirler structure to the annulus.

The present disclosure may include any one or more of the individual features disclosed above and/or below alone or in any combination thereof.

The foregoing features and the operation of the invention will become more apparent in light of the following description and the accompanying drawings.

### BRIEF DESCRIPTION OF THE DRAWINGS

FIG. 1 is a side cutaway illustration of a geared turbine engine.

FIG. 2 is a partial side sectional illustration of a combustor with a fuel injector assembly.

FIG. 3 is a partial side sectional illustration of the fuel injector assembly.

FIG. 4 is a partial side sectional illustration of the fuel injector assembly at an interface between a nozzle guide and a swirler wall.

FIG. 5 is a partial side sectional illustration of the fuel injector assembly at an interface between the nozzle guide and another swirler wall.

FIG. 6 is a cross-sectional illustration of a radial air swirler.

FIGS. 7A-C are partial schematic illustrations of fuel injector nozzles injecting fuel along various trajectories.

FIG. 8 is a partial side sectional illustration of the fuel injector assembly configured with one or more additional air swirlers.

### DETAILED DESCRIPTION

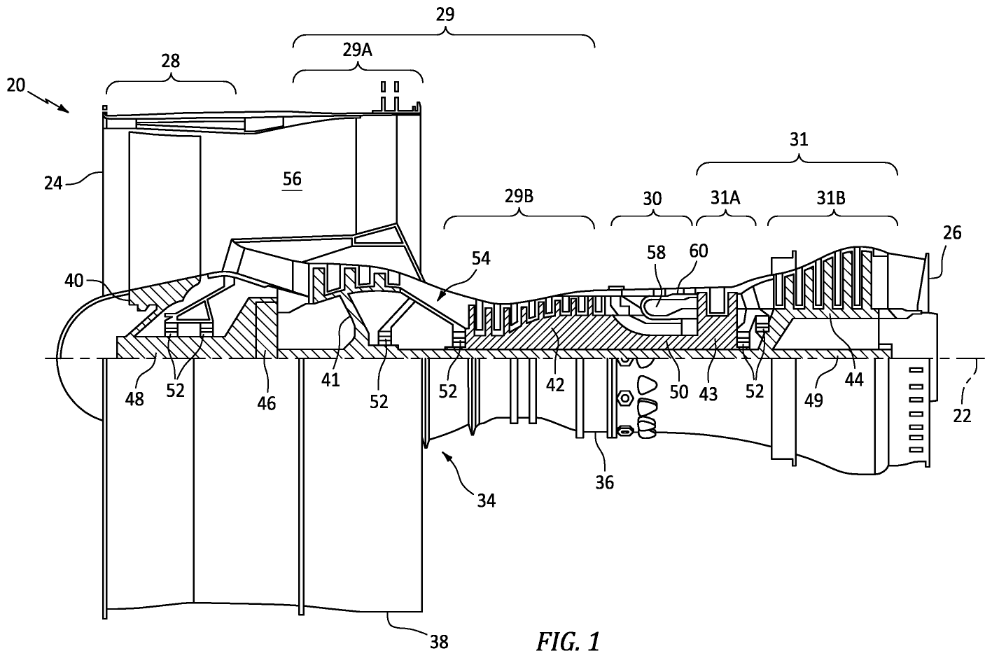

FIG. 1 is a side cutaway illustration of a geared gas turbine engine 20. This gas turbine engine 20 extends along an axial centerline 22 between an upstream airflow inlet 24 and a downstream airflow exhaust 26. The gas turbine engine 20 includes a fan section 28, a compressor section 29, a combustor section 30 and a turbine section 31. The compressor section 29 includes a low pressure compressor (LPC) section 29A and a high pressure compressor (HPC) section 29B. The turbine section 31 includes a high pressure turbine (HPT) section 31A and a low pressure turbine (LPT) section 31B.

The engine sections 28-31B are arranged sequentially along the axial centerline 22 within an engine housing 34. This engine housing 34 includes an inner case 36 (e.g., a core case) and an outer case 38 (e.g., a fan case). The inner case 36 may house one or more of the engine sections 29A, 29B, 30, 31A and 31B; e.g., a core of the gas turbine engine 20. The outer case 38 may house at least the fan section 28.

Each of the engine sections 28, 29A, 29B, 31A and 31B includes a respective bladed rotor 40-44. Each of these bladed rotors 40-44 includes a plurality of rotor blades arranged circumferentially around and connected to one or more respective rotor disks and/or hubs. The rotor blades, for example, may be formed integral with or mechanically fastened, welded, brazed, adhered and/or otherwise attached to the respective rotor disk(s) and/or the respective hub(s).

The fan rotor 40 is connected to a geartrain 46, for example, through a fan shaft 48. The geartrain 46 and the LPC rotor 41 are connected to and driven by the LPT rotor 44 through a low speed shaft 49. The HPC rotor 42 is connected to and driven by the HPT rotor 43 through a high speed shaft 50. The engine shafts 48-50 are rotatably supported by a plurality of bearings 52; e.g., rolling element and/or thrust bearings. Each of these bearings 52 is connected to the engine housing 34 by at least one stationary structure such as, for example, an annular support strut.

During engine operation, air enters the gas turbine engine 20 through the airflow inlet 24. This air is directed through the fan section 28 and into a core flowpath 54 and a bypass flowpath 56. The core flowpath 54 extends sequentially through the engine sections 29A-31B; e.g., the engine core. The air within the core flowpath 54 may be referred to as “core air”. The bypass flowpath 56 extends through a bypass duct, and bypasses the engine core. The air within the bypass flowpath 56 may be referred to as “bypass air”.

The core air is compressed by the LPC rotor 41 and the HPC rotor 42 and directed into a (e.g., annular) combustion chamber 58 of a (e.g., annular) combustor 60 in the combustor section 30. Fuel is injected into the combustion chamber 58 and mixed with the compressed core air to provide a fuel-air mixture. This fuel-air mixture is ignited and combustion products thereof flow through and sequentially cause the HPT rotor 43 and the LPT rotor 44 to rotate. The rotation of the HPT rotor 43 and the LPT rotor 44 respectively drive rotation of the HPC rotor 42 and the LPC rotor 41 and, thus, compression of the air received from an inlet to the core flowpath 54. The rotation of the LPT rotor 44 also drives rotation of the fan rotor 40, which propels bypass air through and out of the bypass flowpath 56. The propulsion of the bypass air may account for a majority of thrust generated by the gas turbine engine 20.

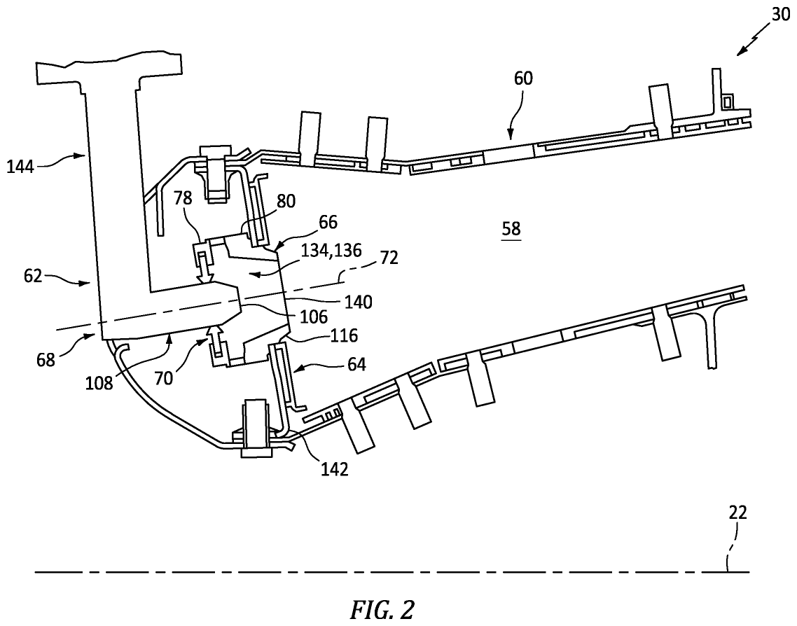

Referring to FIG. 2, the combustor section 30 includes a plurality of fuel injector assemblies 62 (one visible in FIG. 2) arranged circumferentially about the axial centerline 22 in a circular array. The fuel injector assemblies 62 are mounted to a (e.g., annular) bulkhead 64 of the combustor 60. The fuel injector assemblies 62 are configured to direct a mixture of fuel and compressed air into the combustion chamber 58 for combustion. Each fuel injector assembly 62 of FIG. 2 includes an air swirler structure 66 and a fuel injector 68. The fuel injector assembly 62 also includes a nozzle guide 70 (e.g., a guide plate, a slider, a nozzle mount, etc.) coupling the fuel injector 68 to the air swirler structure 66.

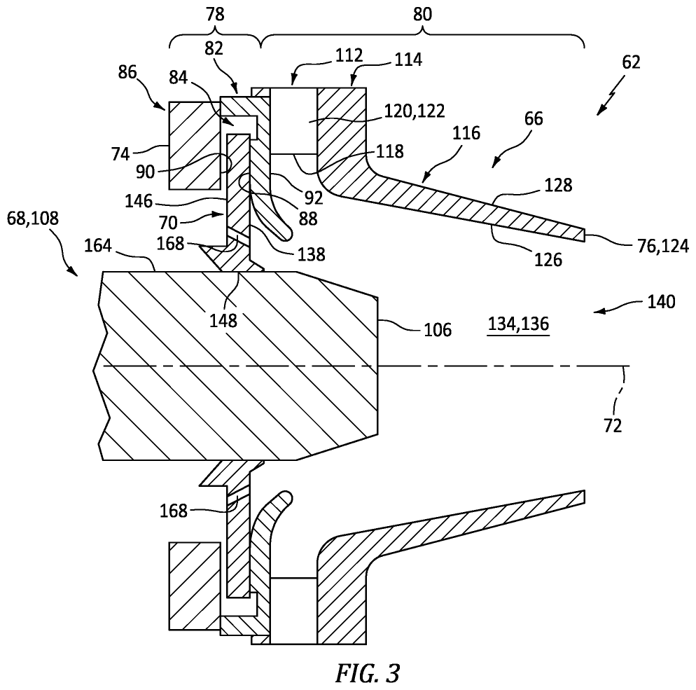

Referring to FIG. 3, the air swirler structure 66 extends circumferentially around an axis 72 (e.g., a centerline of the air swirler structure 66) providing the air swirler structure 66 with a full-hoop body. The air swirler structure 66 extends axially along the axis 72 from an upstream end 74 of the air swirler structure 66 to a downstream end 76 of the air swirler structure 66. The air swirler structure 66 of FIG. 3 includes a base section 78 and a swirler section 80.

The base section 78 is disposed at (e.g., on, adjacent or proximate) the structure upstream end 74. This base section 78 may be configured as or otherwise include a first swirler wall 82; e.g., an annular upstream swirler wall. The base section 78 may also be configured to form a receptacle 84 (e.g., a slot, a channel, etc.) for receiving the nozzle guide 70 at the structure upstream end 74. The base section 78 of FIG. 3, for example, also includes a mounting plate 86 axially abutted against and attached (e.g., mechanically fastened and/or bonded) to the first swirler wall 82. The receptacle 84 is formed at an inner periphery of the base section 78, axially between a (e.g., annular) back surface 88 of the first swirler wall 82 and a (e.g., annular) back surface 90 of the mounting plate 86.

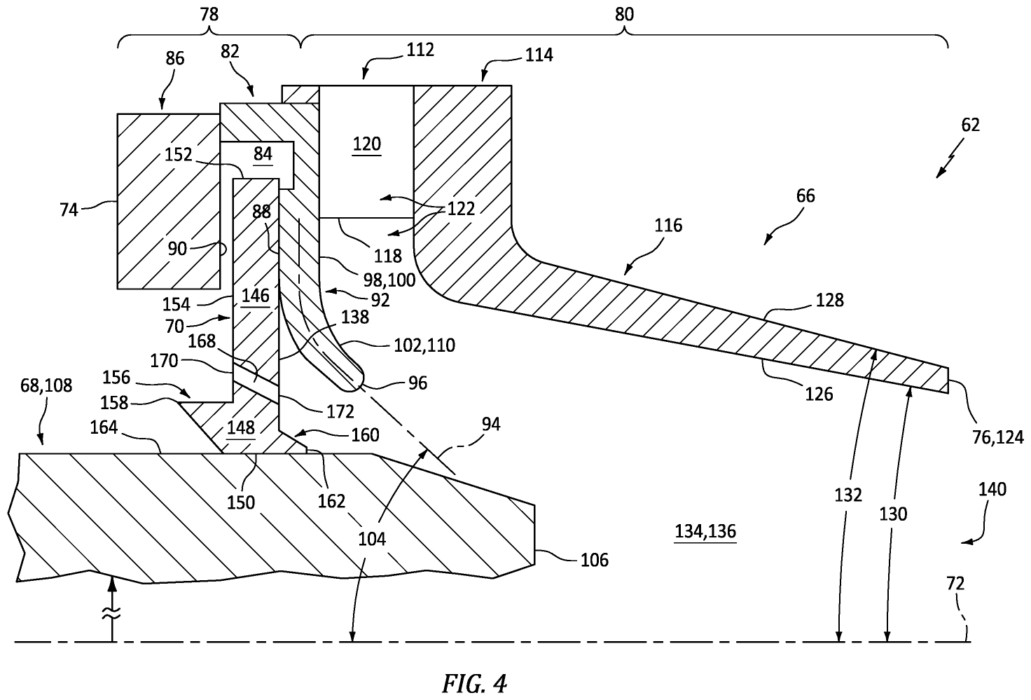

Referring to FIG. 4, the first swirler wall 82 has a thickness that extends laterally between and to the wall back surface 88 and a front flow guide surface 92 of the first swirler wall 82. The first swirler wall 82 and its surfaces 88 and 92 project longitudinally along a longitudinal centerline 94 (e.g., a centerline of a side section of the first swirler wall 82; e.g., section of FIG. 4) in a generally radial inward direction towards the axis 72 to a distal inner end 96 of the first swirler wall 82.

At least a portion or an entirety of the longitudinal centerline 94 along a radial outer portion 98 of the first swirler wall 82 may follow a straight trajectory. An outer portion 100 of the flow guide surface 92 may have a flat and planar geometry. This outer portion 100 of the flow guide surface 92 may also be perpendicular to the axis 72. It is contemplated, however, the outer portion 100 of the flow guide surface 92 may alternatively be angularly offset from the axis 72 by an acute angle equal to or greater than, for example, eighty or eighty-five degrees (80-85°). The radial outer portion 98 of the first swirler wall 82 of FIG. 4 and the wall back surface 88 may form an axial peripheral side of the receptacle 84.

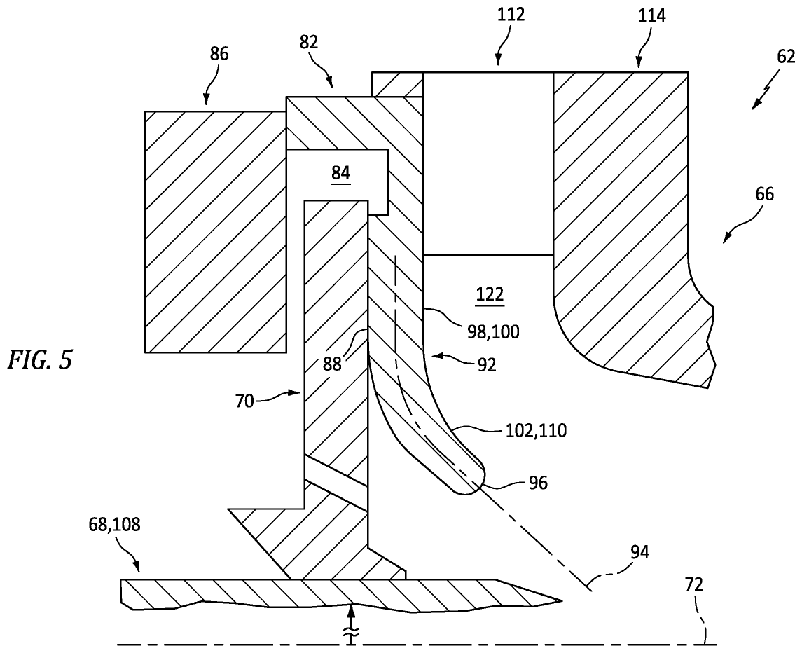

At least a portion or an entirety of the longitudinal centerline 94 along a radial inner portion 102 of the first swirler wall 82 may follow a curved (e.g., arcuate, splined, etc.) trajectory. It is contemplated, however, at least a portion or the entirety of the longitudinal centerline 94 along the radial inner portion 102 of the first swirler wall 82 may alternatively follow a straight trajectory that is canted relative to the longitudinal centerline 94 along the radial outer portion 98 of the first swirler wall 82; e.g., see FIG. 5. The longitudinal centerline 94 along the radial inner portion 102 of the first swirler wall 82 of FIG. 4 is angularly offset from the axis 72 by a non-zero acute angle 104; e.g., between fifteen degrees (15°) and sixty degrees (60°). Thus, a trajectory of the longitudinal centerline 94 along the radial inner portion 102 includes a radial (e.g., inward) component and an axial (e.g., downstream, aft) component. The angle 104 may be selected such that the trajectory of the longitudinal centerline 94 at (or about) the wall inner end 96, for example, may extend towards (e.g., point to or at or about) a tip 106 of an injector nozzle 108. An inner portion 110 of the flow guide surface 92 may have a sloped, canted and/or otherwise tapered geometry; e.g., a frustoconical geometry. At least a portion or an entirety of this tapered geometry may follow a curved trajectory (or a straight trajectory; e.g., see FIG. 5) when viewed, for example, in a reference plane parallel with (e.g., including) the axis 72 and/or the longitudinal centerline 94. With this arrangement, the radial inner portion 102 of the first swirler wall 82 and its inner portion 110 of the flow guide surface 92 is configured as an air flow guide.

The swirler section 80 includes an air swirler 112 and a second swirler wall 114; e.g., an annular downstream swirler wall. The swirler section 80 of FIG. 4 also includes a swirler guide wall 116; e.g., a tubular funnel wall.

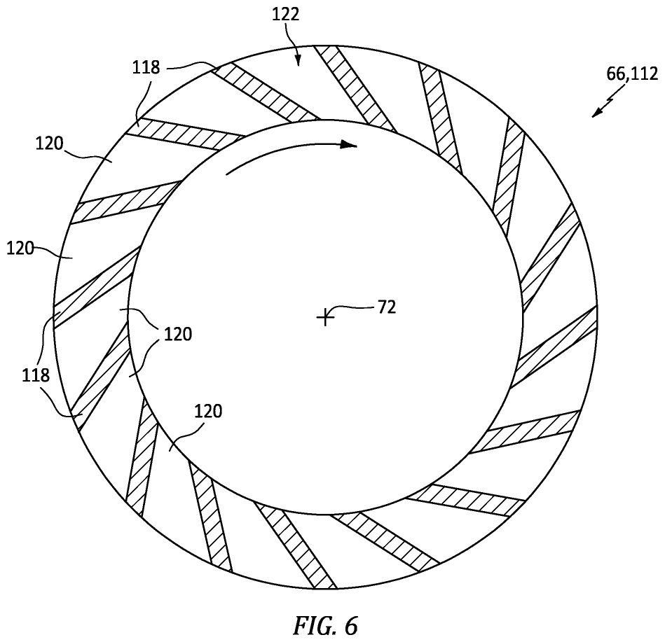

The air swirler 112 may be configured as a radial air swirler. The air swirler 112 of FIG. 4, for example, is arranged axially between and is connected to the first swirler wall 82 and the second swirler wall 114. The air swirler 112 of includes a plurality of air swirler vanes 118; see also FIG. 6. Each of these air swirler vanes 118 extends axially between and is connected to the first swirler wall 82 and its radial outer portion 98 and the second swirler wall 114. Referring to FIG. 6, the air swirler vanes 118 are arranged circumferentially about the axis 72 in a circular array. Each of the air swirler vanes 118 is circumferentially separated from each circumferentially neighboring (e.g., adjacent) air swirler vane 118 by a respective air swirler channel 120; e.g., an air gap. Each air swirler channel 120 extends circumferentially between and to a respective circumferentially neighboring pair of the air swirler vanes 118. Each air swirler channel 120 of FIG. 4 extends axially between and to the first swirler wall 82 and its radial outer portion 98 and the second swirler wall 114. With this arrangement, the air swirler channels 120 of FIGS. 4 and 6 collectively form at least a portion of an air swirler passage 122 radially through the air swirler 112, axially between the swirler walls 82 and 114. The air swirler vanes 118/the air swirler channels 120 are configured such that air passing through and out of the air swirler passage 122 is directed in a first circumferential direction (e.g., a clockwise direction, or alternatively a counterclockwise direction) about the axis 72. In other words, the air swirler vanes 118/the air swirler channels 120 are operable to circumferentially swirl the air passing through the air swirler 112 in the first circumferential direction.

Referring to FIG. 4, the swirler guide wall 116 is disposed at the structure downstream end 76. The swirler guide wall 116 of FIG. 4, for example, is connected to (and cantilevered from) the second swirler wall 114 at an inner end of the air swirler 112. This swirler guide wall 116 projects out from the second swirler wall 114 and extends axially along the axis 72 to a (e.g., downstream) distal end 124 of the swirler guide wall 116 at the structure downstream end 76. As the swirler guide wall 116 extends towards (e.g., to) the structure downstream end 76, the swirler guide wall 116 may (e.g., continuously or incrementally) radially taper inwards towards the axis 72. The swirler guide wall 116 may thereby have a tubular frustoconical geometry with frustoconical inner and/or outer surfaces 126 and 128. Each of these guide wall surfaces 126, 128 is angularly offset from the axis 72 by a respective non-zero acute angle 130, 132. Each of these angles 130, 132 may be less than the angle 104. Each of the angles 130, 132 may be between ten degrees (10°) and forty-five degrees (45°). The present disclosure, however, is not limited to the foregoing exemplary arrangement.

Referring to FIG. 3, the air swirler structure 66 is further configured with a swirler inner passage 134. This inner passage 134 is formed by an inner bore 136 of the air swirler structure 66, which inner bore 136 extend axially through the air swirler structure 66 between and to the structure upstream end 74 and the structure downstream end 76. An outer peripheral boundary of an upstream portion of the inner passage 134 may be formed by and radially within the base section 78 and its first swirler wall 82. An outer peripheral boundary of a downstream portion of the inner passage 134 may be formed by and radially within the swirler section 80 and its swirler guide wall 116. The inner passage 134 of FIG. 3 extends axially within the air swirler structure 66 from (or about) a side 138 of the nozzle guide 70 to an inner swirler outlet 140 (e.g., an outlet orifice) at the structure downstream end 76.

Referring to FIG. 2, the air swirler structure 66 may be mated with the combustor bulkhead 64. The swirler guide wall 116, for example, may project axially into or through a respective port in the combustor bulkhead 64. The air swirler structure 66 may also be mounted to the combustor bulkhead 64. For example, the swirler segment 80 (e.g., the second swirler wall 114 and/or the swirler guide wall 116 of FIG. 3) may be bonded (e.g., brazed or welded) and/or otherwise connected to the combustor bulkhead 64 and, more particularly, a shell 142 of the combustor bulkhead 64. However, various other techniques are known in the art for mounting an air swirler structure to a combustor bulkhead (or various other combustor components), and the present disclosure is not limited to any particular ones thereof.

The fuel injector 68 of FIG. 2 includes a fuel injector stem 144 and the fuel injector nozzle 108. The injector stem 144 is configured to support and route fuel to the injector nozzle 108. The injector nozzle 108 is cantilevered from the injector stem 144. The injector nozzle 108 projects along the axis 72 (e.g., a centerline of the injector nozzle 108) partially into the inner bore 136 of the air swirler structure 66. The nozzle tip 106 is thereby disposed within the inner passage 134. Here, the nozzle tip 106 is axially spaced from the inner swirler outlet 140 by an axial distance along the axis 72.

Referring to FIG. 4, the nozzle guide 70 includes a nozzle guide base 146 (e.g., an annular plate) and a nozzle guide foot 148 (e.g., a bearing and/or slide member). The nozzle guide 70 extends radially between and to an inner side 150 of the nozzle guide 70 and an outer side 152 of the nozzle guide 70. The nozzle guide 70 and each of its members 146 and 148 extends circumferentially about (e.g., completely around) the axis 72. The nozzle guide 70 may thereby be configured with a full-hoop annular body.

The guide base 146 projects radially outward (e.g., away from the axis 72) from the guide foot 148 to the guide outer side 152; e.g., a radial outer distal end of the guide base 146. The guide base 146 extends axially along the axis 72 between and to opposing axial sides 138 and 154 of the guide base 146. The guide base 146 of FIG. 4 is disposed radially outboard of and circumscribes the guide foot 148.

The guide foot 148 is disposed at the guide inner side 150. An upstream portion 156 of the guide foot 148 may project axially out from the upstream axial side 154 of the guide base 146 to an upstream end 158 of the guide foot 148. This upstream portion 156 of the guide foot 148 may radially taper outward away from the axis 72 and the injector nozzle 108 as the upstream portion 156 of the guide foot 148 projects axially along the injector nozzle 108 to the foot upstream end 158. With this arrangement, the guide foot 148 is radially spaced from the injector nozzle 108 at the foot upstream end 158. In addition or alternatively, a downstream portion 160 of the guide foot 148 may project axially out from the downstream axial side 138 of the guide base 146 to a downstream end 162 of the guide foot 148. This downstream portion 160 of the guide foot 148 may radially taper inward towards the axis 72 and the injector nozzle 108 as the downstream portion 160 of the guide foot 148 projects axially along the injector nozzle 108 to the foot downstream end 162. With this arrangement, the guide foot 148 may be radially adjacent (or close to) the injector nozzle 108 at the foot downstream end 162. This arrangement also positions the downstream portion 160 of the guide foot 148 radially inward to provide room (e.g., clearance) for the first swirler wall 82.

The nozzle guide 70 is configured to couple the injector nozzle 108 to the air swirler structure 66 and, thus, the bulkhead 64 (see FIG. 2). The nozzle guide 70 and its guide base 146, for example, may project radially into the receptacle 84, where the nozzle guide 70 and its guide base 146 may be (e.g., loosely) captured axially between the first swirler wall 82 and the mounting plate 86. This capturing of the nozzle guide 70 between the first swirler wall 82 and the mounting plate 86 may facilitate the nozzle guide 70 and its guide base 146 to radially float (e.g., shift) within the receptacle 84. The nozzle guide 70 and its guide base 146, for example, may axially abut against, but slide radially from the axis 72 along the first swirler wall 82 and/or the mounting plate 86. This floating may in turn accommodate (e.g., slight) radial shifting between the air swirler structure 66 and the fuel injector 68 and its injector nozzle 108 during gas turbine engine operation.

Referring to FIG. 3, the injector nozzle 108 is mated with the nozzle guide 70. The injector nozzle 108, for example, projects axially through an inner bore of the guide foot 148. The guide foot 148 thereby extends axially along and circumscribes the injector nozzle 108. The guide foot 148 is configured to radially engage (e.g., contact) an outer cylindrical bearing surface 164 (e.g., a land surface) of the injector nozzle 108. The guide foot 148 is further configured to move (e.g., slide, translate, etc.) axially along the injector nozzle 108 and its bearing surface 164. This relative movement between the guide foot 148 and the injector nozzle 108 and its bearing surface 164 may in turn accommodate (e.g., slight) axial shifting between the air swirler structure 66 and the fuel injector 68 and its injector nozzle 108 during gas turbine engine operation.

During operation of the fuel injector assembly 62 of FIG. 3, air (e.g., the compressed core air from the HPC section 29B of FIG. 1) is directed into the air swirler passage 122. This air flows radially through the air swirler passage 122, longitudinally along the first swirler wall 82 and its flow guide surface 92 and is directed into the inner passage 134; e.g., a portion of the inner bore 136 downstream of the nozzle guide 70. As the air passes through the air swirler 112 and the air swirler passage 122, the stream of air is swirled in the first circumferential direction (see FIG. 6). The air stream directed through the air swirler 112 into the inner passage 134 is therefore (or otherwise includes) swirled air. This swirled air is then directed axially through the inner passage 134 and is discharged from the air swirler structure 66 through the inner swirler outlet 140.

As the swirled air flows along the first swirler wall 82, the first swirler wall 82 and its flow guide surface 92 guide the swirled air away from a corner (e.g., an interface/intersection) between the nozzle guide 70 and the injector nozzle 108. The first swirler wall 82 and its flow guide surface 92 may thereby facilitate a relatively smooth flow of the swirled air out of the air swirler passage 122 and into the inner passage 134. For example, the first swirler wall 82 may reduce flow separation at a swirler inlet. More particularly, by extending the first swirler wall 82 of FIG. 4 with its radial inner portion 102, the flow guide surface 92 may be extended along a contour of a flow field of the air swirler 112. Providing the radial inner portion 102 may also significantly reduce a size of a low pressure region forming at the corner between the nozzle guide 70 and the injector nozzle 108. By contrast, if the radial inner portion 102 of the first swirler wall 82 was omitted, the air may recirculate at the corner between the nozzle guide 70 and the injector nozzle 108 and create a relatively large low pressure region at the corner. This recirculating air may cause flow disturbances (e.g., turbulence) in a flow stream of the swirled air out of the air swirler passage 122 and into the inner passage 134. Such flow disturbances may cause downstream combustor instabilities.

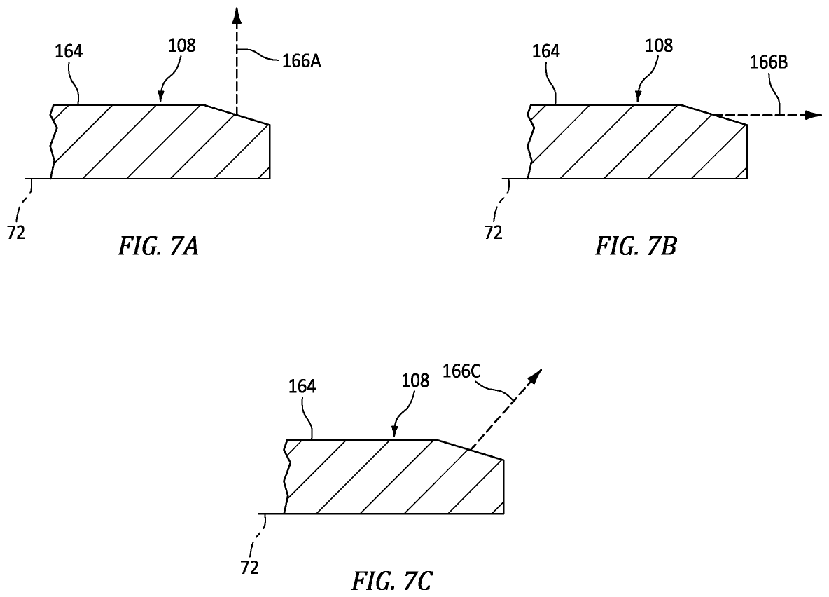

The fuel injected by the injector nozzle 108 for mixing with the swirled air may be a hydrocarbon fuel such as kerosene or jet fuel and/or a non-hydrocarbon fuel such as hydrogen fuel (e.g., H₂ gas). Referring to FIG. 7A, the fuel may be directed out of the injector nozzle 108 in a substantially radial direction (e.g., see line 166A) from one or more fuel nozzle outlets. Referring to FIG. 7B, the fuel may alternatively (or also) be directed out of the injector nozzle 108 in a substantially axial direction (e.g., see line 166B) from one or more fuel nozzle outlets. Referring to FIG. 7C, the fuel may alternatively (or also) be directed out of the injector nozzle 108 in a canted (e.g., axial and radial; diagonal) direction (e.g., see line 166C) from one or more fuel nozzle outlets. The present disclosure, however, is not limited to the foregoing exemplary injector nozzle configurations.

In some embodiments, referring to FIG. 4, the nozzle guide 70 may include one or more purge apertures 168 (one visible in FIG. 4) arranged circumferentially about the axis 72 in a circular array. Each purge aperture 168 is configured to purge (e.g., stagnant and/or recirculating) air out of a gap between the elements 70, 82 and 108. Each purge aperture 168 of FIG. 4, for example, extends across the guide base 146 (radially above the guide foot 148) from an inlet 170 into the respective purge aperture 168 to an outlet 172 from the respective purge aperture 168. The aperture inlet 170 is disposed in the upstream axial side 154. The aperture outlet 172 is disposed in the downstream axial side 138. The purge apertures 168 may be canted inward towards the bearing surface 164, or parallel to the bearing surface 164. In another example, the purge aperture 168 may be configured to generate (or not generate) swirl of the purge air. The present disclosure, however, is not limited to such an exemplary purge aperture arrangement.

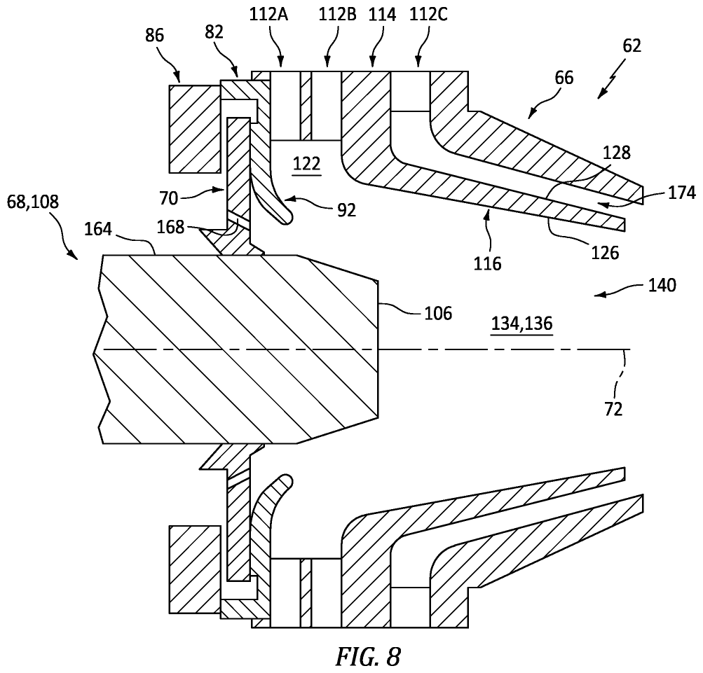

In some embodiments, referring to FIG. 3, the air swirler structure 66 may be configured with a single air swirler. In other embodiments, referring to FIG. 8, the air swirler may alternatively be one of a plurality of air swirlers 112A-C (generally referred to as “112”). In the embodiment of FIG. 8, the first air swirler 112A and the second air swirler 112B are each configured to direct (counter or co) swirled air radially into the inner bore 136 and its inner passage 134. The second air swirler 112B may be configured similar to the first air swirler 112A, except positioned axially downstream of the first air swirler 112A. The first air swirler 112A, for example, may be arranged axially between (a) the nozzle guide 70/the first swirler wall 82 and (b) the second air swirler 112B. The first air swirler 112A may also be axially aligned with (e.g., axially overlap) the injector nozzle 108; e.g., axially arranged between (a) the nozzle guide 70/the first swirler wall 82 and (b) the nozzle tip 106. The third air swirler 112C, on the other hand, may be configured to direct swirled air into an outer swirler passage 174 (e.g., an annulus within the air swirler structure 66) that circumscribes and extends along the swirler guide wall 116. This third air swirler 112C may swirl a third stream of air in the first circumferential direction (e.g., a common direction as the first air swirler 112A and/or the second air swirler 112B), or in the second circumferential direction about the axis 72 that is opposite the first circumferential direction. The present disclosure, however, is not limited to such an exemplary multi-air swirler configuration. For example, in other embodiments, the air swirler structure 66 may include one or more additional radial and/or axial flow air swirlers. In still other embodiments, the second air swirler 112B or the third air swirler 112C may be omitted to provided, for example, a dual air swirler arrangement.

The fuel injector assembly(ies) 62 may be included in various turbine engines other than the one described above. The fuel injector assembly(ies) 62, for example, may be included in a geared turbine engine where a geartrain connects one or more shafts to one or more rotors in a fan section, a compressor section and/or any other engine section. Alternatively, the fuel injector assembly(ies) 62 may be included in a direct drive turbine engine configured without a geartrain. The fuel injector assembly(ies) 62 may be included in a turbine engine configured with a single spool, with two spools (e.g., see FIG. 1), or with more than two spools. The turbine engine may be configured as a turbofan engine, a turbojet engine, a turboprop engine, a turboshaft engine, a propfan engine, a pusher fan engine or any other type of turbine engine. The turbine engine may alternatively be configured as an auxiliary power unit (APU) or an industrial gas turbine engine. The present disclosure therefore is not limited to any particular types or configurations of turbine engines.

While various embodiments of the present disclosure have been described, it will be apparent to those of ordinary skill in the art that many more embodiments and implementations are possible within the scope of the disclosure. For example, the present disclosure as described herein includes several aspects and embodiments that include particular features. Although these features may be described individually, it is within the scope of the present disclosure that some or all of these features may be combined with any one of the aspects and remain within the scope of the disclosure. Accordingly, the present disclosure is not to be restricted except in light of the attached claims and their equivalents.

1. An assembly for a turbine engine, comprising:
an air swirler structure including a swirler wall, an inner passage and an air swirler passage, the swirler wall including a flow guide surface and a back surface, at least an inner portion of the flow guide surface having a frustoconical geometry, the inner passage extending axially along an axis within the air swirler structure to a swirler outlet, the air swirler passage extending radially into the air swirler structure, and the air swirler passage extending longitudinally along the flow guide surface within the air swirler structure and to the inner passage;
an injector nozzle projecting axially into the inner passage, the swirler wall, the flow guide surface and the back surface each extending along a centerline to a distal inner end of the swirler wall, and the centerline having a trajectory extending towards a tip of the injector nozzle; and
a nozzle guide coupling the injector nozzle to the air swirler structure, the nozzle guide axially abutted against and radially slidable along the back surface.

2. (canceled)

3. The assembly of claim 1, wherein
the air swirler structure further includes a mounting plate connected to the swirler wall; and
an outer portion of the nozzle guide is received within a receptacle formed by and axially between the swirler wall and the mounting plate.

4. The assembly of claim 1, wherein the nozzle guide is radially abutted against the injector nozzle.

5. The assembly of claim 1, wherein the nozzle guide circumscribes and is slidable axially along the injector nozzle.

6. The assembly of claim 1, wherein at least a portion of the frustoconical geometry follows a straight line trajectory in a reference plane parallel with the axis.

7. The assembly of claim 1, wherein at least a portion of the frustoconical geometry follows a curved trajectory in a reference plane parallel with the axis.

8. The assembly of claim 1, wherein
the swirler wall is a first swirler wall, and the air swirler structure further includes a second swirler wall and a plurality of swirler vanes;
the air swirler passage is formed by and is axially between the first swirler wall and the second swirler wall; and
each of the plurality of swirler vanes extends axially across the air swirler passage from the first swirler wall to the second swirler wall.

9. The assembly of claim 8, wherein
the plurality of swirler vanes are connected to a radial outer portion of the first swirler wall; and
a radial inner portion of the first swirler wall includes the inner portion of the flow guide surface having the frustoconical geometry.

10. The assembly of claim 1, wherein an outer portion of the flow guide surface has a planar geometry.

11. The assembly of claim 1, wherein an outer portion of the flow guide surface is perpendicular to the axis.

12. (canceled)

13. The assembly of claim 1, wherein a purge aperture extends axially across the nozzle guide.

14. The assembly of claim 1, wherein
the nozzle guide includes a foot that radially engages the injector nozzle; and
a first portion of the foot radially tapers towards the injector nozzle as the first portion of the foot projects axially into the inner passage along the injector nozzle.

15. The assembly of claim 1, wherein
the air swirler passage is a first air swirler passage, and the air swirler structure further includes a second air swirler passage;
the first air swirler passage is axially between the second air swirler passage and the swirler wall; and
the second air swirler passage extends radially into the air swirler structure towards and is fluidly coupled with the inner passage.

16. The assembly of claim 1, wherein
the air swirler passage is a first air swirler passage, and the air swirler structure further includes an annulus and a second air swirler passage;
the annulus is radially outboard from the inner passage, and the annulus extends circumferentially about and axially along the inner passage; and
the second air swirler passage extends radially into the air swirler structure to the annulus.

17. An assembly for a turbine engine, comprising:
an air swirler structure including a swirler wall, an inner passage and an air swirler passage, the swirler wall extending along a centerline to a distal inner end of the swirler wall, the centerline including a radial component and an axial component, the inner passage extending axially along an axis within the air swirler structure to an outlet from the air swirler structure, and the air swirler passage extending radially into the air swirler structure, longitudinally along the swirler wall and to the inner passage;
an injector nozzle projecting axially into the inner passage; and
a nozzle guide coupling the injector nozzle to the air swirler structure, the nozzle guide configured to axially abut against the swirler wall, a purge aperture extending axially across the nozzle guide from an aperture inlet into the purge aperture to an aperture outlet from the purge aperture, the aperture outlet located radially inboard of the distal inner end of the swirler wall, and the purge aperture configured to direct air into a gap radially between the injector nozzle and the swirler wall.

18. The assembly of claim 17, wherein a trajectory of the centerline at the distal inner end of the swirler wall points at a tip of the injector nozzle.

19. The assembly of claim 17, wherein
the swirler wall includes a flow guide surface; and
at least an inner portion of the flow guide surface at the distal inner end of the swirler wall has a frustoconical geometry.

20. An assembly for a turbine engine, comprising:
an air swirler structure including a first swirler wall, a second swirler wall, an inner passage, an air swirler passage and a plurality of swirler vanes, the inner passage extending axially along an axis within the air swirler structure, the air swirler passage formed by and extending axially between the first swirler wall and the second swirler wall, the air swirler passage extending from an inlet into the air swirler passage radially into the air swirler structure, longitudinally along the first swirler wall and to the inner passage, and each of the plurality of swirler vanes extending axially across the air swirler passage from the first swirler wall to the second swirler wall at the inlet into the air swirler passage;
an injector nozzle; and
a nozzle guide coupling the injector nozzle to the air swirler structure, the nozzle guide configured to axially engage the first swirler wall;
the first swirler wall comprising a flow guide surface configured to direct air flowing out of the air swirler passage into the inner passage downstream and away from a corner between the nozzle guide and the injector nozzle; and
the injector nozzle projecting axially into the inner passage beyond a distal inner end of the flow guide surface.

21. The assembly of claim 17, wherein
the purge aperture extends longitudinally along an aperture centerline from the aperture inlet to the aperture outlet, and the aperture centerline is angularly offset from the axis by a first acute angle; and
a trajectory of the centerline at the distal inner end of the swirler wall is angularly offset from the axis by a second acute angle that is greater than the first acute angle.
